(19) United States
(12) Patent Application Publication
(10) Pub. No.: US 2006/0124073 A1
(43) Pub. Date: Jun. 15, 2006

(54) Versatile dog house

(76) Inventors: William Croft, Mooresville, NC (US); Frederick Cruz, Apple Creek, OH (US); John Vura, Wooster, OH (US); Brian Pleiman, Medina, OH (US)

Correspondence Address: MARSHALL, GERSTEIN & BORUN LLP, 233 S. WACKER DRIVE, SUITE 6300, SEARS TOWER, CHICAGO, IL, 60606, US

(21) Appl. No.: 10/725,816

(22) Filed: Dec. 2, 2003

Related U.S. Application Data
(60) Provisional application No. 60/430,109, filed on Dec. 2, 2002.

(51) Int. Cl. A01K 1/03

(52) U.S. Cl. 119/482

(57) ABSTRACT

A dog house includes a floor panel with a perimeter, a sidewall extending up from the floor panel, an opening formed in the sidewall sized to allow canine ingress and egress, and a top panel hingedly attached to the sidewall and shiftable between and open position and a closed position.

### FIELD OF THE DISCLOSURE

The present invention relates to a dog house and, more particularly, to a dog house that adapts one or more needs of a growing dog.

### BACKGROUND OF THE DISCLOSURE

Dog houses typically include a floor, four walls extending up from the floor, and a roof that covers the walls and defines the interior space of the dog house. One of the walls typically includes an appropriately sized entrance opening that permits the dog to enter and leave the dog house.

Most dog houses are typically placed outdoors and provide shelter for a dog from the rain and the wind. Heartier dogs can stay in their dog houses in cold weather, especially if the dog house includes some insulation. Apparently, dogs enjoy the feeling of safety and security that sleeping in their own den provides.

Dog houses are normally fixed structures. The sidewalls are fastened to the floor, and the roof is fastened to the sidewalls to create a fixed enclosure having a fixed volume. The fixed nature of the common doghouse may create one or more problems. For example, dogs may have an accident in the dog house or may drag food items into the dog house. Additionally, many dogs emit an odor that can cause the dog house to smell unpleasant. Any one of these circumstances creates the need to clean the dog house. The common dog house is difficult to clean due to the fact that the only opening is the entrance opening which, of course, is sized to permit entry of a dog rather than a human.

Further, the common dog house suffers from a lack of cross ventilation. Typically, the only way for stale air to escape is through the entrance opening, and thus air generally does not travel into and out of the dog house very easily. This air stagnation contributes to the build up of unpleasant odors. Further, stagnant air also contributes to the build up of heat in the summer.

The fixed nature of the common dog house creates a fixed interior space and a fixed interior volume. As a puppy grows into a dog, the dog requires a larger dog house. Thus, an owner either can purchase new, larger dog houses as a dog grows, or the owner can purchase a large dog house and let the puppy grow into it. Neither of these alternatives are acceptable, in that in the first instance, the user must expend unnecessary money, and in the second instance, the puppy can be uncomfortable in the large enclosure.

### BRIEF DESCRIPTION OF THE DRAWINGS

FIG. 1 is a front perspective view of the dog house constructed in accordance with the teachings of the present invention.

FIG. 2 is a front perspective view of the dog house of FIG. 1, with the roof panel rotated to an open position.

FIG. 3 is a front perspective view of the dog house of FIG. 1, with the front wall in a middle position.

FIG. 4 is a front perspective view of the dog house of FIG. 1, with the front wall in a back position.

FIG. 5 is back perspective view of the dog house of FIG. 1.

FIG. 6 is a side elevation view of the dog house of FIG. 1.

FIG. 7 is a top view of the floor panel.

FIG. 8 is a side cross sectional view of the floor panel of FIG. 8, taken along line 9-9.

FIG. 9 is an elevation view of the outside of the right wall.

FIG. 10 is an elevation view of the front of the right wall

FIG. 11 is an elevation view of the inside of the right wall.

FIG. 12 is an elevation view of the outside of the left wall.

FIG. 13 is an elevation view of the front side of the left wall

FIG. 14 is an elevation view of the inside of the left wall.

FIG. 15 is a top view of the left wall.

FIG. 16 is an elevation view of the front wall.

FIG. 17 is an elevation view of the side of the front wall.

FIG. 18 is an elevation view of the rear wall.

FIG. 19 is a elevation view of the side of the rear wall.

FIG. 20 is a cross-sectional side view of the rear wall taken along line 20-20 in FIG. 18.

FIG. 21 is a perspective view of the inside of the ventilation door.

FIG. 22 is a perspective view of the outside of the ventilation door.

FIG. 23 is a top view of the roof panel.

FIG. 24 is a view of the bottom side of the top panel.

FIG. 25 is a side cross sectional view of the top panel taken along line 25-25: in FIG. 24.

FIG. 26 is a cross sectional view of the hinge between the right panel and the roof panel when the roof panel is in the closed position.

FIG. 27 is a cross sectional view of the hinge of FIG. 26 when the roof panel is in the open position.

FIG. 28 is a cross sectional side view of the dog house in the assembled condition.

While the disclosure is susceptible to various modifications and alternative constructions, certain illustrative embodiments thereof have been shown in the drawings and will be described below in detail. It should be understood, however, that there is no intention to limit the disclosure to the specific form or forms disclosed but, on the contrary, the intention is to cover all modifications, alternative constructions, and the equivalents falling within the spirit and scope of the invention as defined by the appended claims.

### DETAILED DESCRIPTION

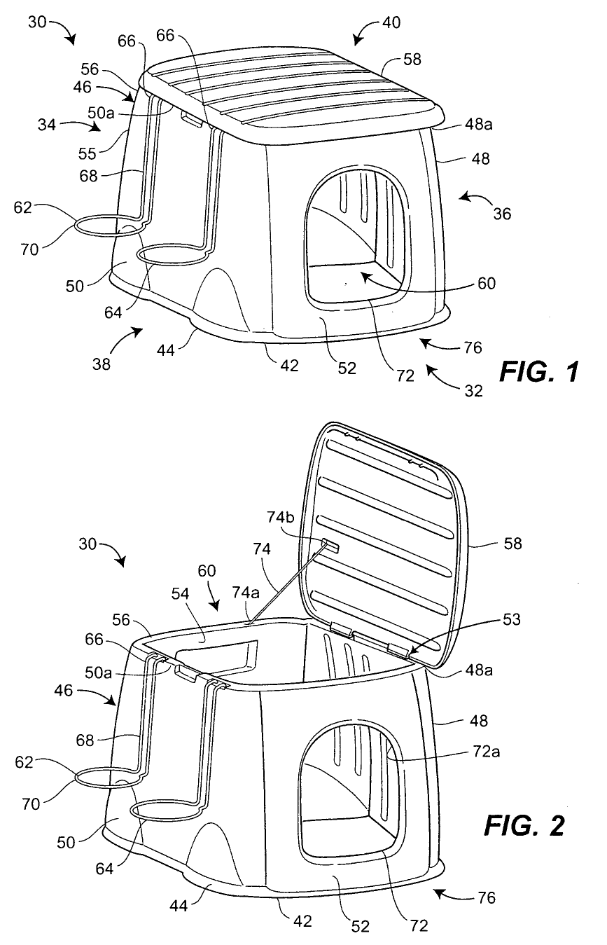

Referring now to the drawings, and in particular to FIG. 1, a dog house 30 assembled in accordance with the teachings of the present invention is shown. The dog house 30 includes a floor panel 42 and a sidewall 46 that is attached to the floor panel 42 and has an upper edge 56. An access opening 72 is formed is the sidewall 46 to allow the dog ingress and egress. A roof panel 58 is attached to the sidewall 46 and is shiftable between an open position and a closed position.

The dog house 30 has a front side 32, a rear side 34, a right side 36, a left side 38, and a top side 40. The dog house 30 includes a floor panel 42 with an outer perimeter 44. Extending up from the floor panel 42 is a sidewall 46. In this example, the sidewall 46 extends up from the outer perimeter 44 of the floor panel 42. Alternatively, the sidewall 46 need not extend from the perimeter 44 of the floor panel 42. In this example, the sidewall 46 includes a right panel 48, a left panel 50, a front panel 52, and a back panel 54. Other examples not shown include a sidewall 46 that includes more or less panels.

The sidewall 46 defines an upper portion 55 and, more specifically, the sidewall 46 includes an upper edge 56. A roof panel 58 is disposed on the upper edge 56 of the sidewall 46. The floor panel 42, the sidewall 46, and the roof panel 58 define an internal space 60.

A first hanger 62 and a second hanger 64 are disposed over the upper edge 56 of the outer wall 46. In the disclosed example, the hangers 62 and 64 are disposed over an upper edge 50a of the left panel 50. Each hanger 62, 64 includes a hook 66 that hangs over the upper edge 50a of the panel 50, it being understood that the hangers 62, 64 may be arranged to hang over another one of the panels. An extension 68 of the hangers 62 and 64 extends downward from the hook 66, and a securing area 70 extends outward from the extension 68. The securing area 70 may be sized to receive a food dish, a water dish, or other pet-related accessory.

The outer wall 46 includes an access opening 72 sized to allow a dog or other animal to enter and exit the internal space 60. In this example, the access opening 72 is a hole 72a in the front panel 52. However, the access opening 72 may extend all the way to the floor panel 42. As a further alternative, the opening 72 may be formed in the panels 48, 50 or 54 and, may also be formed at the intersection of two panels.

Referring now to FIG. 2, the dog house 30 is shown with the roof panel 58 in the open position. The roof panel 58 includes a hinge 53 at the upper edge 48a of the panel 48 such that the roof panel 58 is rotatable between a closed position shown in FIG. 1 to an open position shown in FIG. 2. In the closed position shown in FIG. 1, the bottom surface of the roof panel 58 is generally flush with the upper edge 56 of the outer wall 46. In the open position shown in FIG. 2, the roof panel 58 has been rotated such that the roof panel 58 only touches the,wall panel 48 at the hinge 53. It will be understood that the hinge 53 may permit the roof panel 58 to be released from the outer wall 46, such that the entire roof panel 58 can be removed from the dog house 30.

In the example shown in FIG. 2, the roof panel 58 is rotated approximately 900 and is help in place by a brace 74 having one end 74a connected to the wall panel 54 and another end 74b connected to the roof panel 58. Alternatively, a flexible cable can be used.

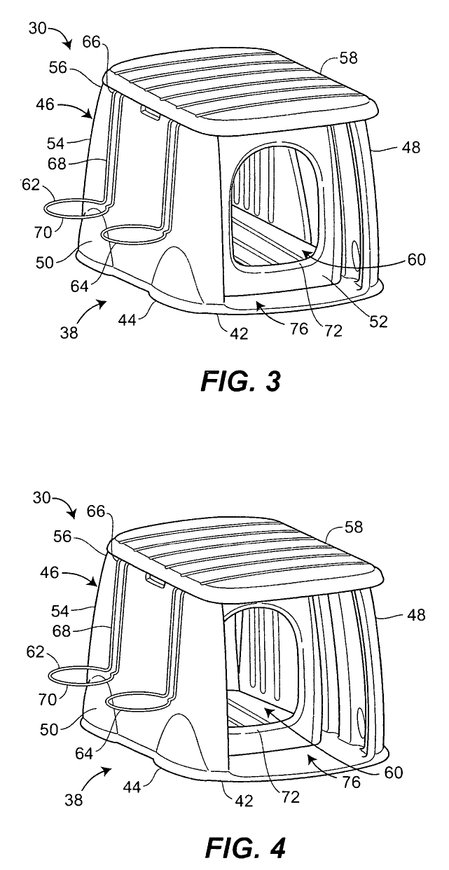

Referring now to FIGS. 1, 3, and 4, the front panel 52 is preferably moveable to a plurality of positions. More specifically, the front panel may be movable between a forward position shown in FIG. 1, to a middle position shown in FIG. 3 and FIG. 28, or to a rearward position shown in FIG. 4. By incorporating a moveable panel as illustrated in the disclosed example, volume of the interior space 60 of the dog house 30 can be changed.

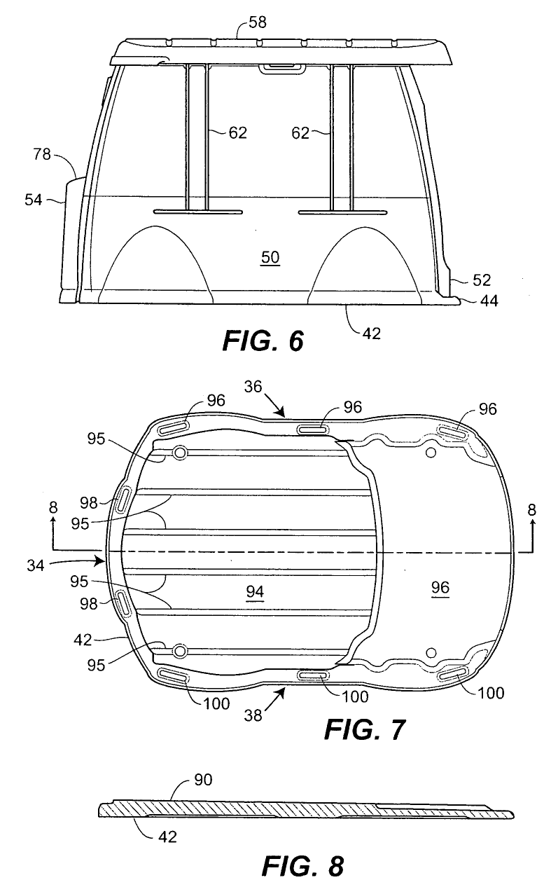

As can be seen in FIGS. 3 and 4, when the front panel 52 is in the middle or back position, the left panel 50, the right panel 52, the roof panel 58, and the floor panel 42 all extend out past the front panel 52 to form a recessed entrance area 76 that may serve as, for example, a wind break and/or a rain guard. This may be advantageous as the dog may extend its head out or legs out of the access opening 72 without being pelted by rain or wind. As can be seen in FIG. 6, even when the front panel 52 is in the forward position, the roof panel 58 can extend outward past the front panel 52, to create a rain guard.

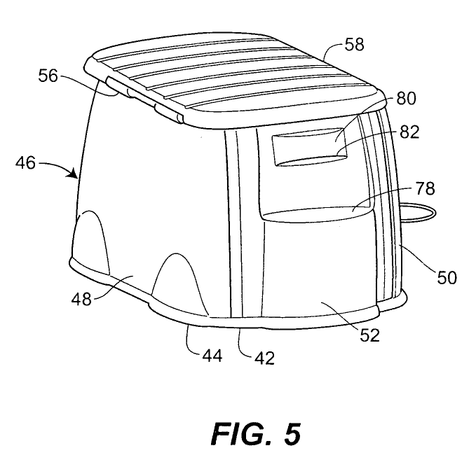

Referring now to FIG. 5, the back side of the dog house 30 is shown. The rear panel 54 can include a ventilation opening 80 and a door 82 in the ventilation opening 80. The door 82 can be moved between an open position and a closed position. The rear panel 54 can further include a ledge 78. When the door 82 is in an open position, air can flow from the access opening 72 in the front panel 52 through the internal space 60 of the dog house 30, and out the ventilation opening 80. Thus, a stream of air can easily flow through the dog house 30, thereby bringing fresh air in helping to keep the dog house from having a bad odor. Further, the fresh air helps to protect against the internal space 60 of the dog house 30 having a temperature that is too high during the summer.

The structure of the individual panels will now be discussed in greater detail. Although the hereafter described construction has been found to be useful, other constructions and configurations will also be easily seen by those of skill in the art. The floor panel 42 is shown in FIGS. 7 and 8. The floor panel 42 can be disposed on a support surface such as the ground or the floor of a house. The floor panel 42 includes a top surface 90 upon which the dog can stand, an entrance section 92, and an interior section 94. The top surface 90 in the interior section 94 may include ribs 95 for added strength. When the front panel 52 is in the back position, the front panel 52 is disposed in between the interior section 94 and the entrance section 92.

A series of receiver holes are disposed along the outer perimeter 44 of the floor panel 42. The right panel receiver holes 96 are disposed along the right side 36, the rear panel receiver holes 98 are disposed along the rear side 34, and the left panel receiver holes 100 are disposed along the left side 38. The receiver holes 96, 98, 100 are adapted to receive snaps from the right panel 48, the rear panel 54, and the left panel 50 to fasten the respective panels 48, 50, 54 to the floor panel 42 in an upright fashion so that the floor panel 42 supports the respective panels 48, 50, 54.

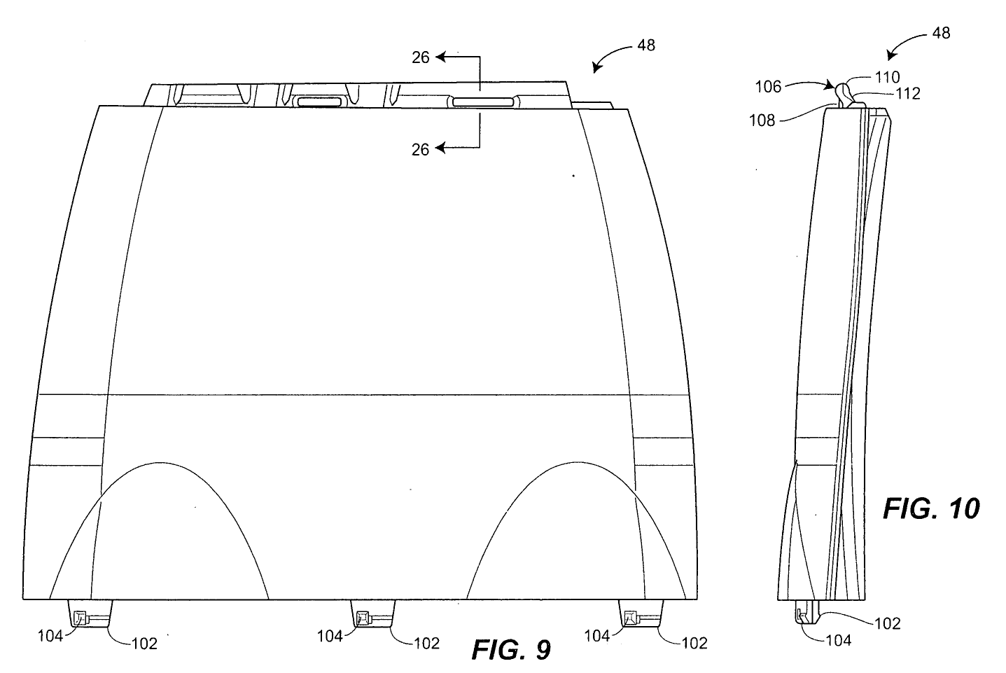

Referring now to FIGS. 9, 10, and 11, the right panel 48 is shown. The right panel 48 includes snaps 102, each with a retainer 104, for insertion into the right panel receiver holes 96 in the floor panel 42. As the snaps 102 are inserted into the respective receiver holes 96, the respective retainers 104 extend outward, locking the snaps 102 in the receiver holes 96.

The hinge 53 includes a hinge pin member 106 on the upper edge 56 of the right panel 48. The hinge pin member 106 can extend the entire length, or as depicted in FIG. 9, a portion of the length of the right panel 48. The hinge pin member 106 includes a connector 108 and a cylinder 110. The connector 108 includes a stop surface 112 and connects the cylinder 110 to the upper edge 56 of the right panel 48. The cylinder 110 is adapted to rotatably secure the roof panel 58 to the right panel 48, as will be seen later.

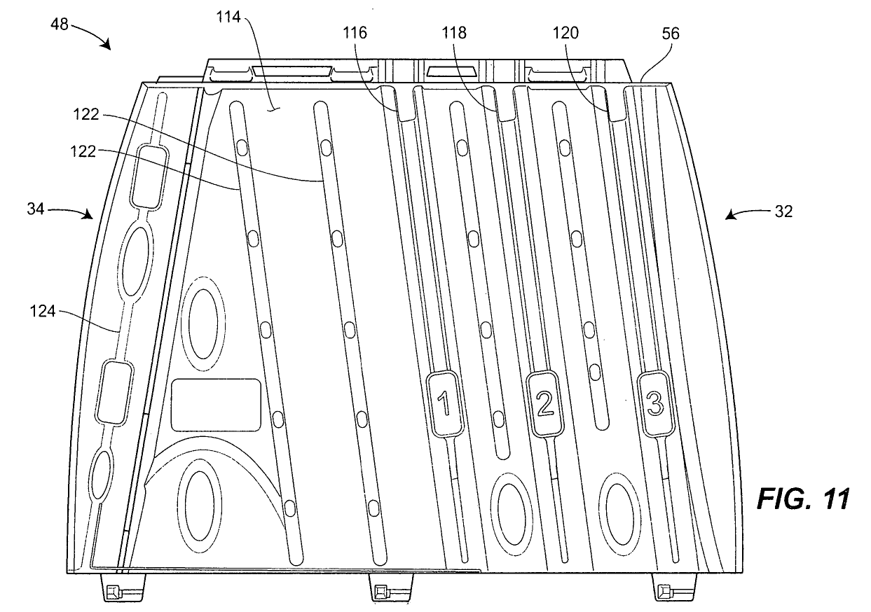

Referring now to FIG. 11, the inner surface 114 of the right panel 48 is shown. The inner surface 114 includes a first slot 116, a second slot 118, and a third slot 120. The right panel slots 116, 118, 120 are open on the upper edge 56 of the right panel 48, but are closed on their bottom end. The slots 116, 118, 120 are configured to receive the front panel 52 so that the front panel 52 can be slid into the open end and down into the slot, as shown in FIGS. 1-5. The front panel 52 being disposed in the third slot 120 corresponds to the front panel 52 being in the forward position. The second slot 118 corresponds to the middle position, and the first slot 116 corresponds to the back position.

The right panel 48 also includes a series of depressions 122. The depressions 122 increase the rigidity of the right panel 48. The right panel 48 further includes a rear slot 124. The rear slot 124 is configured to receive and secure the rear panel 54 to the right panel 48.

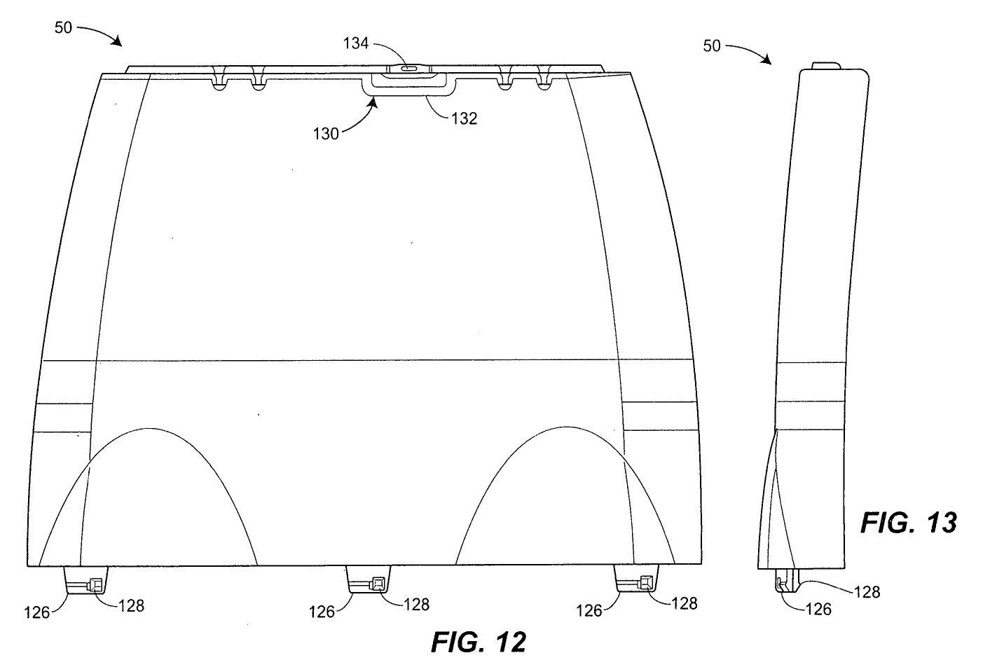

Referring now to FIGS. 12, 13, 14 and 15, the left panel 50 is disclosed. The left panel 50 includes three snaps 126, each with a retainer 128. The snaps 126 are adapted to be disposed into the left panel receiver holes 100 in the floor panel 42 to fasten the left panel 50 to the floor panel 42. This is similar to that as was previously described with respect to the right panel 48.

The left panel 50 further includes a fastening portion 130 on the upper edge 56. The fastening portion 130 includes a depression 132 in the upper edge 56 and a protrusion 134 extending substantially laterally, such that when the roof panel 58 is rotated down onto the upper edge 56 of the left wall 50, as is shown in FIG. 1, a snap in the roof panel 58 is forced past the protrusion 134 into the depression 132. This holds the roof panel 58 flush against the upper edge 56 because the snap cannot easily move upward past the protrusion 134.

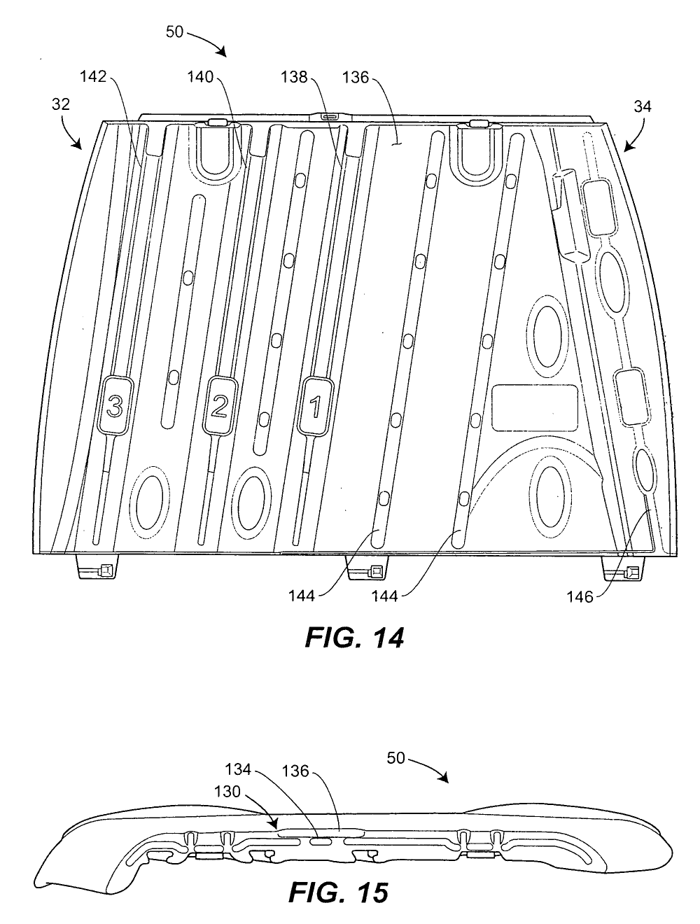

Referring now to FIG. 14, the left panel 50 has an inner face 136. A first slot 138, a second slot 140, and a third slot 142 are disposed on the inner face 136 and correspond to the three slots 116, 118, 120 on the right panel 48. The three slots 138, 140, 142 of the left panel 50 are open at the upper edge 56 to accommodate the insertion and sliding down of the front panel 52 into the slot. The three slots 138, 140, 142 are closed on their bottom sides to ensure that the front panel 52 is maintained in the slots 138, 140, 142. This is similar in structure and function to the slots 116, 118, 120 of the right panel 48.

The left panel 50 further includes a plurality of depressions 144 to increase rigidity. Finally, the left panel 50 includes a rear panel slot 146 such that the rear panel 54 can be placed in the rear panel slot 146 and maintained between the left panel 50 and the right panel 48 in a fixed position.

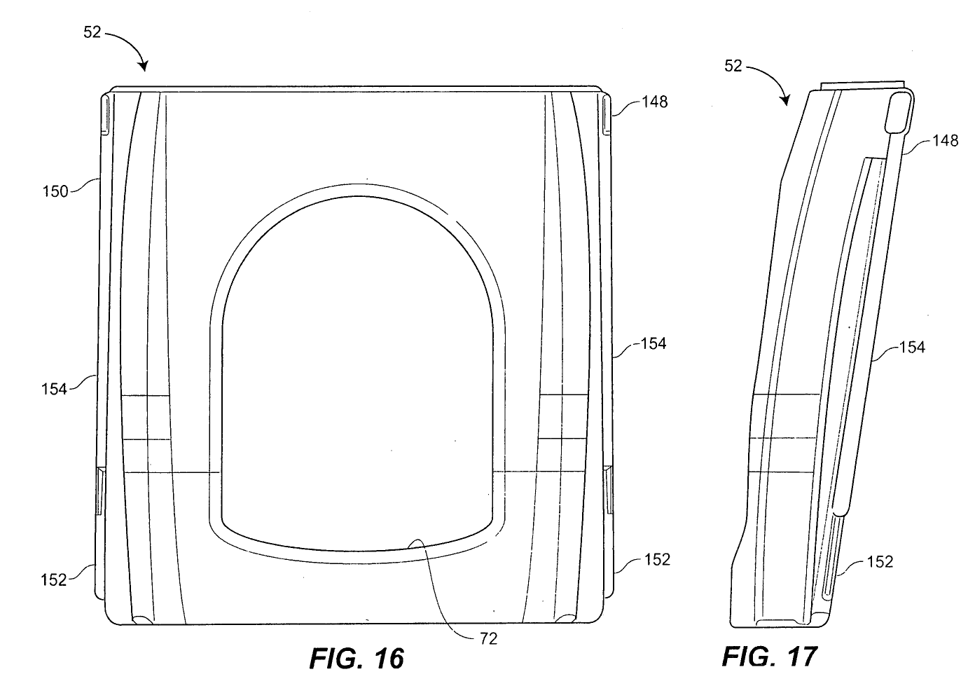

Referring now to FIGS. 16 and 17, the front panel 52 is disclosed. The front panel 52 includes the access opening 72 and a first rail 148 and a second rail 150. Each rail 148, 150 can have a narrow portion 152 and a wide portion 154. The first rail 148 can be slid down into one of the three slots 116, 118, 120 on the right panel 48, and the second rail 150 can be slid into one of the three slots 138, 140, 142 on the left panel 50.

Thus, by sliding the rails 148, 150 of the front panel 52 into one of the slots 116, 118, 120 on the right panel 48 and a corresponding slot 138, 140, 142 on the left panel 50, the user can select how large the internal space 60 of the dog house 30 should be. If the dog is a puppy, the user can slide the rails 148, 150 of the front panel 52 into the first slots 116, 138 of the right and left panels 48,50 to make the internal space 60 of the dog house 30 smaller. As the puppy grows into a dog, the user can enlarge the internal spacing by removing the front panel 52 from the first slots 116, 138 and moving the front panel 52 to the second slots 118, 140 and ultimately the third slots 120, 142.

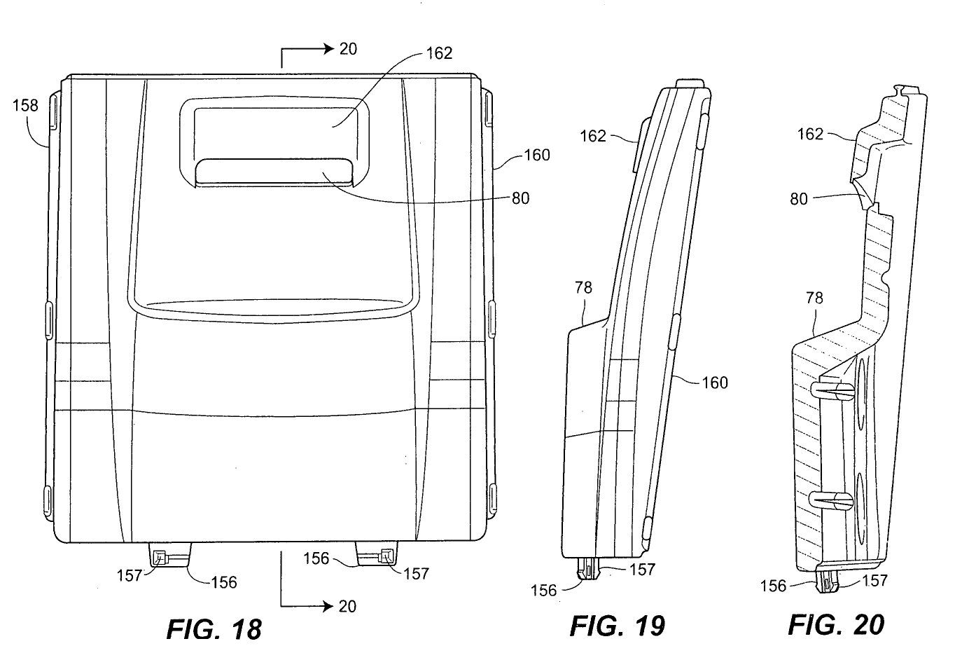

Referring now to FIGS. 18, 19, and 20, the rear panel 54 is shown. The rear panel 54 includes snaps 156 with retainers 157 adapted to be inserted into the rear panel receiver holes 98 of the floor panel 42, similar to the right and left panels 48,50, so that the rear panel 54 is removably secured to the floor panel 42. The rear panel 54 further includes a first and a second rail 158, 160 that are adapted to be inserted into the rear panel slot 124 of the right panel 48 and the rear panel slot 146 of the left panel 50, respectively to secure the rear panel 54 to the right and left panels 48, 50.

In one example, a ledge can extend out from the rear panel 52 is a ledge 78. In other examples not shown, the ledge can be recessed into the rear panel 52. As is shown, the ledge 78 can be substantially parallel to the roof panel 58.

The rear panel 52 further includes the ventilation opening 80. Extending down over the ventilation opening 80 is an awning 162. The awning 162 can prevent unwanted debris from entering the dog house 30, such as leaves, bugs, etc. The awning 162 can also provide a handle for the user to more easily carry the dog house 30.

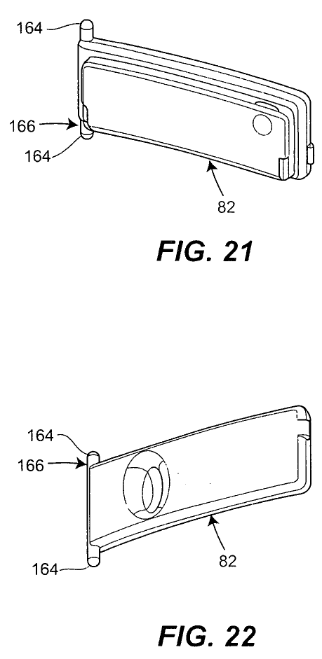

Disposed within the ventilation opening 80 is the door 82, depicted in FIGS. 21 and 22. The door 82 can include a pair of posts 164 extending out from the door 82 in opposite directions that define a connecting hinge 166. The connecting hinge 166 can be inserted into receiving holes (not shown) in the rear panel 54 such that the door 82 can be rotated from a closed position in which the ventilation opening 80 is closed, to an open position in which air can flow from the access opening 72, through the internal space 60, and out the ventilation opening 80. By opening the door 82 in the ventilation opening 80, air can flow though the dog house 30, remove odors therein, and protect against overheating within the dog house 30 during the summer.

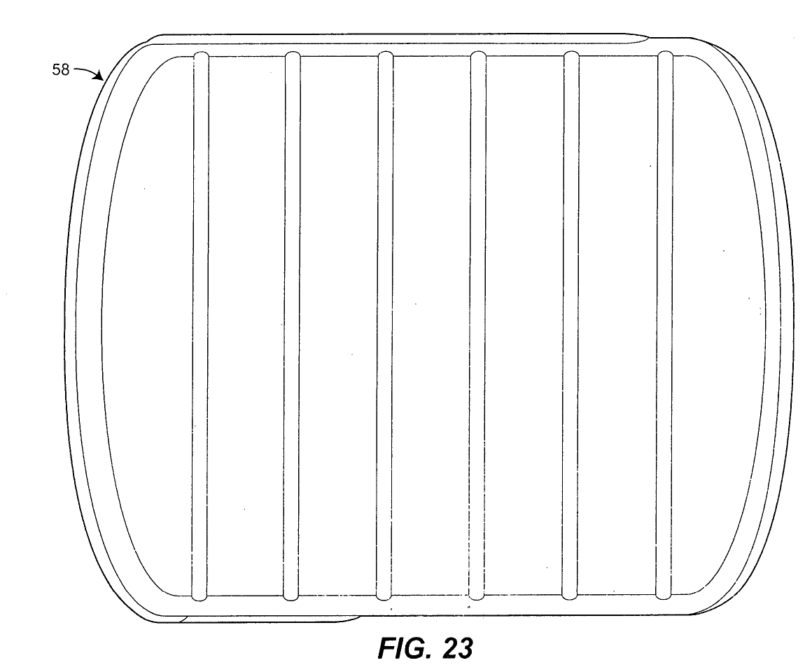

Referring now to FIGS. 23, 24, and 25, the roof panel 58 is disclosed. The roof panel 58 can include several depressions 168 along both its length and width to increase strength. The roof panel 58 can include a snap 170 on the left side 38 adapted to engage the depression 132 and the protrusion 134 at the upper edge 56 of the left panel 50 when the roof panel 58 is in the closed position.

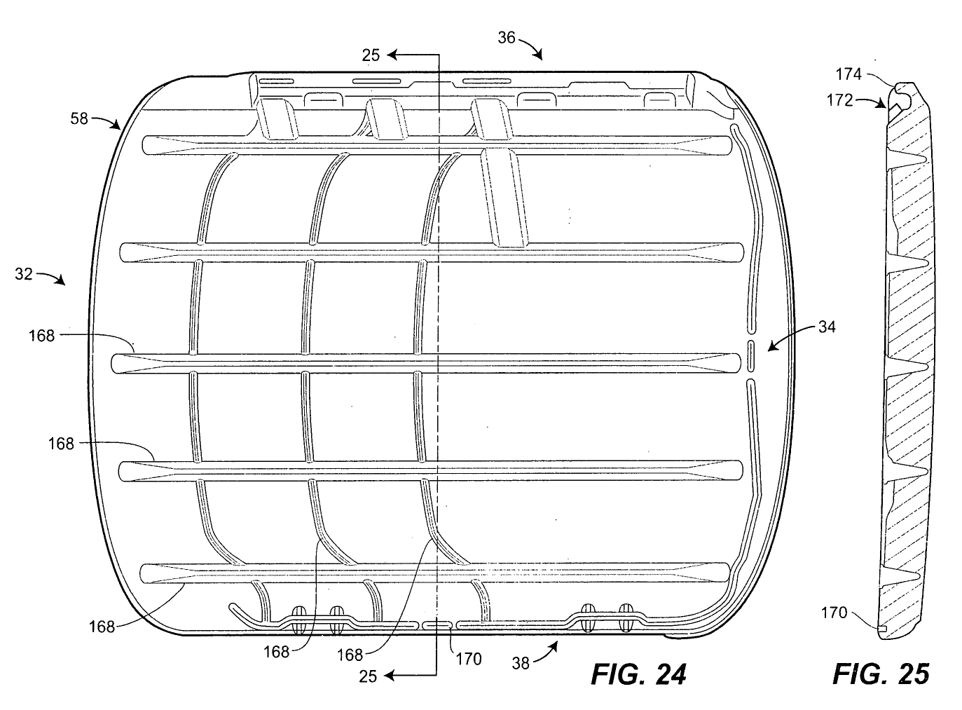

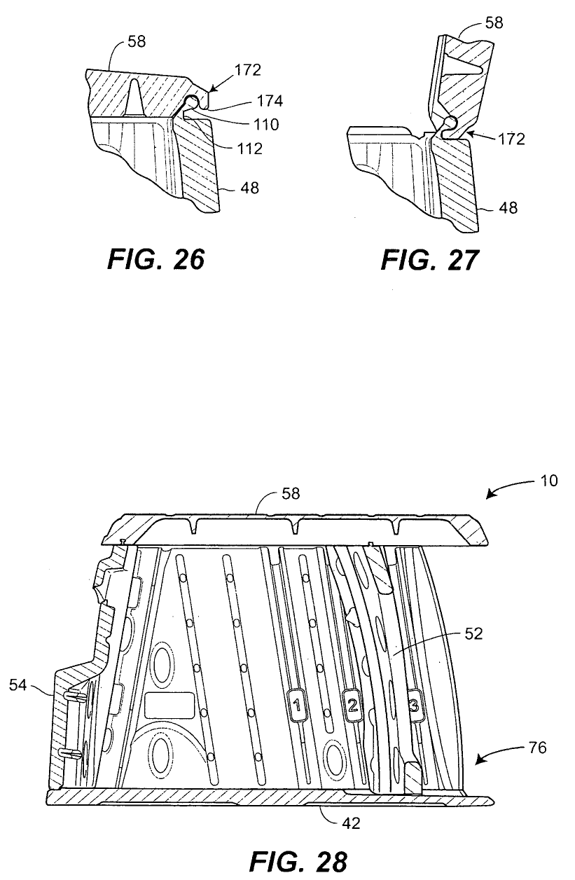

Along the right side 36 of the roof is a hinge receiver 172. The hinge receiver 172 can have a circular cross sectional shape, defining approximately 3/4 of a circle. As can best be seen in FIGS. 26 and 27, the hinge receiver 172 of the roof panel 58 can be placed on the hinge pin member 106 of the right panel 48 to define the hinge 53. The hinge receiver 172 includes a bearing surface 174. The roof panel 58 can be rotated through approximately one quarter of a turn or slightly greater than one quarter of a turn from the closed position shown in FIGS. 1 and 24 to the open position shown in FIG. 2 and 24 in which the bearing surface 174 engages the stop surface 112 of the hinge pin member 106 to limit rotation of the roof panel 58 about the hinge pin member 106. Other constructions of a hinge can also be used.

Thus, the roof panel 58 can be rotated to open the top side 40 of the dog house 30. It can also be seen that the roof panel 58 can be completely removed from the dog house 30 by pulling the roof panel 58 off of the hinge pin member 106. The user can then easily clean out the internal space 60 of the dog house 30. The user could also be able to reach a dog that may be unwilling to leave its dog house 30. The user can clean the dog house 30 in any suitable manner. It is believed that applying a stream of water such as that from a garden hose can quickly clean the internal space 60. If the front panel 52 is removed prior to applying the stream of water, the internal space 60 can be cleaned even faster and easier.

In the disclosed example, an elevated food dish or water dish may be provided by virtue of the hangers 62 and 64. This may be helpful to a dog in that the dog does not have to lower its head to access its food. This can be especially helpful in older dogs with arthritic joints that may have trouble supporting their head in a lowered position.

Also, by virtue of the fact that the disclosed example that permits the interior volume to be adjusted, a puppy that might not feel safe inside a large dog house may have a smaller house, while a large dog does not feel comfortable with a small dog house may have a larger dog house. Thus, puppies may feel more comfortable and secure and larger dogs can have enough room to maneuver inside the house. In other words, various size dogs enjoy the safety and comfort of having a den that is appropriately sized.

Also, when the dog is a puppy, the front panel 52 can be placed in the back position to provide the puppy with a secure feeling. As the puppy grows into a dog, the front panel 52 can be moved to the middle position and ultimately to the forward position to give the dog adequate space. Thus, the exemplary moveable front panel 52 provides for the needs of a growing pet without the owner being required to purchase a new dog house.

From the foregoing, one of ordinary skill in the art will appreciate that the present disclosure sets forth a measuring apparatus. However, one of ordinary skill in the art could readily apply the novel teachings of this disclosure to any number of situations. As such, the teachings of this disclosure shall not be considered to be limited to the specific examples disclosed herein, but to include all applications within the spirit and scope of the invention.

We claim:

1. A dog house, comprising:
a floor panel;
a sidewall attachable to the floor panel and having an upper edge;
an opening formed in the sidewall to allow a canine ingress and egress; and
a roof panel attached to the sidewall and shiftable between and open position and a closed position.

2. The dog house of claim 1, wherein the floor panel has an outer perimeter and the sidewall extends upward from the outer perimeter.

3. The dog house of claim 1, wherein the sidewall comprises a plurality of panels.

4. The dog house of claim 3, wherein the sidewall includes a front panel, a rear panel, a left panel, and a right panel.

5. The dog house of claim 1, the roof panel being connected to the sidewall by a hinge, wherein the roof panel can pivot about the hinge.

6. The dog house of claim 5, wherein the hinge includes a hinge pin member, the hinge pin member including a cylinder.

7. The dog house of claim 6, wherein the roof panel includes a substantially circular hinge pin receiver.

8. The dog house of claim 7, the hinge pin member including a stop surface and the hinge pin receiver including a bearing surface, wherein the stop surface restricts rotation of the roof panel.

9. The dog house of claim 7, wherein the hinge pin member is removable from the hinge pin receiver to remove the roof panel from the sidewall.

10. The dog house of claim 1, wherein the floor panel includes a plurality of receiver holes and the sidewall includes a plurality of snaps sized to releasably attach the sidewall to the floor panel.

11. The dog house of claim 1, further including a ledge associated with the rear panel.

12. A method of forming a dog house, the method comprising the steps of:
providing a floor panel and an attachable sidewall, at least a portion of the sidewall having a opening;
providing a roof panel shiftably attached to the sidewall, the roof panel shiftable between a closed position in which an interior of the dog house in generally enclosed and an open position in which the interior of the dog house is accessible through a roof opening.

13. The dog house of claim 12, wherein the floor panel has an outer perimeter and the sidewall extends upward from the outer perimeter.

14. The dog house of claim 12, wherein providing the sidewall includes providing a plurality of panels.

15. The dog house of claim 14, wherein providing the plurality of panels includes providing a front panel, a rear panel, a left panel, and a right panel.

16. The dog house of claim 12, further comprising connecting the roof panel to the sidewall by a hinge, wherein the roof panel can pivot about the hinge.

17. The dog house of claim 12, the sidewall including a hinge pin member, wherein the hinge pin member includes a substantially cylindrical pin.

18. The dog house of claim 17, further comprising rotatably attaching the sidewall to the roof panel by disposing the substantially cylindrical pin in a substantially circular hinge pin receiver in the roof panel.

19. The dog house of claim 18, further comprising stopping rotation of the hinge pin receiver about the hinge pin member by contacting a stop surface on the hinge pin member against a bearing surface on the hinge pin receiver.

20. The dog house of claim 18, further comprising removing the hinge pin member from the hinge pin receiver to remove the roof panel from the sidewall.

21. The dog house of claim 12, further comprising releasably attaching the sidewall to the floor panel by inserting snaps on the sidewall into receiver holes in the floor panel.

22. A dog house, comprising:
a floor panel;
a sidewall attachable to the side panel and defining an upper portion;
a roof panel attached to the sidewall at the upper portion, the floor panel, sidewall and roof panel defining an internal space;
a first opening disposed in the sidewall sized to-allow a canine ingress and egress; and
a second opening spaced away from the first opening and cooperating with the first opening to define an air flow path between the first opening and the second opening.

23. A dog house, comprising:
a floor panel;
a sidewall attachable to the floor panel, the floor panel and sidewall defining an internal space;
an opening formed in the sidewall sized to allow a canine ingress and egress;
the sidewall including at least a first panel shiftable between a first position and a second position, the internal space when the sidewall is in the first position being different than the internal space when the sidewall is in the second position.

24. A dog house, comprising:
a floor panel;
a sidewall attachable to the floor panel and having an upper portion;
an opening formed in the sidewall sized to allow a canine ingress and egress;
a roof panel attachable to the sidewall at the upper portion, the roof panel extending past the sidewall above the opening to form a rain guard.
